(19) United States
(12) Patent Application Publication
(10) Pub. No.: US 2001/0042800 A1
(43) Pub. Date: Nov. 22, 2001

(54) Electromagnetic fuel injection valve

(75) Inventor: Kouji Sato, Saitama Prefecture (JP)

Correspondence Address: OSTROLENK FABER GERB & SOFFEN, 1180 AVENUE OF THE AMERICAS, NEW YORK, NY, 100368403

(73) Assignee: Bosch Automotive Systems Corporation

(21) Appl. No.: 09/829,556

(22) Filed: Apr. 10, 2001

(30) Foreign Application Priority Data
Oct. 13, 1999 (JP) 11-291269

(51) Int. Cl. F02M 51/00

(52) U.S. Cl. 239/585.1; 239/585.5

(57) ABSTRACT

The present invention provides an electromagnetic fuel injection valve, is capable of lowering fuel consumption and reducing emissions by promoting the mixing of injected fuel with air, and, in addition, is capable of obtaining numerous variations in spray or injection quantity, as the result of reduced emissions by promoting combustion via the atomization of injected fuel. It is a novel electromagnetic fuel injection valve, which has been designed, focusing on devising specifications for injection orifices 14, 15, for example, the attitude or angle of inclination, shape, and number thereof, and is constituted such that jets of fuel injected from injection orifices 14, 15 are made to impinge upon one another, and are injected as a flat-shaped spray 17, being characterized in that the angles of inclination θ of the injection orifices 14, 15 relative to the axis 5C of a needle valve 5 are made to differ from one another.

### BACKGROUND OF THE INVENTION

1. Field of the Invention

The present invention relates to an electromagnetic fuel injection valve, and more particularly to an electromagnetic fuel injection valve for in-cylinder direct fuel injection in a system, which directly injects gasoline and other such fuels into a combustion chamber.

2. Description of the Related Art

As for the spray configuration in a conventional electromagnetic fuel injection valve for in-cylinder direct fuel injection, there is a cone shaped configuration that makes use of the swirling flow of a fuel, but this configuration is limited when it comes to enhancing fuel atomization and the state of an air/fuel mixture.

Accordingly, as in Japanese Utility Model Application Laid-open No. S59-172276, Japanese Utility Model Application Laid-open No. H5-83366, Japanese Patent application Laid-open No. H8-144762, and Japanese Patent Application Laid-open No. H8-177499, for example, there are cases in which a high-pressure fuel is injected by either changing the spray shape or as a flat-shaped spray (fan spray), by causing fuel jets to impinge on one another after being injected from at least a pair of injection orifices.

That is, a spray spreads out uniformly in an oval shape or flat shape, and the atomization of a fuel is achieved via the impinging of the above-mentioned high-pressure jets, and, in addition, the mixing of the air and fuel inside a combustion chamber is performed satisfactorily. Since the shape or configuration of this spray is thin and wide, the adherence of fuel to the top surface of a piston at compression, when a piston rises up inside a combustion chamber, is held in check, making it possible to prevent worsening emissions.

However, the problem is that it is difficult to obtain numerous variations in spray or injection quantity via an electromagnetic fuel injection valve in accordance with spray shape or configuration, the cylinder head mounting structure, or the combustion characteristics of an internal combustion engine and so forth.

### SUMMARY OF THE INVENTION

With the foregoing problems in view, it is an object of the present invention to provide an electromagnetic fuel injection valve capable of improving the atomization of injected fuel and air/fuel mixability.

Further, an object of the present invention is to provide an electromagnetic fuel injection valve, which reduces emissions by promoting combustion via the atomization of injected fuel, and, in addition, is capable of lowering fuel consumption and reducing emissions by promoting the mixing of injected fuel with air.

Further, an object of the present invention is to provide an electromagnetic fuel injection valve capable of readily executing the specifications of a spray injected from an injection orifice and flow specifications, and the characteristic control thereof.

Further, an object of the present invention is to provide an electromagnetic fuel injection valve capable of achieving numerous variations of a spray and injection quantity.

In other words, the present invention devises specifications for an injection orifice, for example, the attitude or angle of inclination, shape, and number thereof, and more specifically, focuses on changing the angle of inclination of each injection orifice, using at least two pairs of injection orifices, changing the cross-sectional shape of the aperture of each injection orifice of a pair of injection orifices, and adding a third injection orifice. A first invention is an electromagnetic fuel injection valve having an electromagnetic coil; a nozzle body, in which at least a pair of injection orifices are formed such that jets of injected fuel from these injection orifices impinge upon one another inside a combustion chamber; and a needle valve, which sits on the seat portion of this nozzle body, and, in addition, is capable of opening and closing the above-mentioned injection orifices by exciting the above-mentioned electromagnetic coil, being constituted such that the above-mentioned jets resulting from fuel injected from the above-mentioned injection orifices are made to impinge upon one another, and are injected as a flat-shaped spray, this electromagnetic fuel injection valve being such that the respective angles of inclination of the above-mentioned injection orifices relative to the axis of the above-mentioned needle valve are made to differ from one another.

As for the above-mentioned injection orifice of the one side, this can be formed parallel to the above-mentioned axis of the above-mentioned needle valve, and as for the above-mentioned injection orifice of the other side, this can be formed so as having a predetermined angle of inclination relative to the above-mentioned axis of the above-mentioned needle valve.

A second invention is an electromagnetic fuel injection valve, having an electromagnetic coil; a nozzle body, in which forms at least a pair of injection orifices are formed such that jets of injected fuel from the injection orifices impinge upon one another inside a combustion chamber; and a needle valve, which sits on the seat portion of this nozzle body, and which is capable of opening and closing the above-mentioned injection orifices by exciting the above-mentioned electromagnetic coil, said electromagnetic fuel injection valve being constituted such that the above-mentioned jets of fuel injected from the above-mentioned injection orifices are made to impinge upon one another, and are injected as a flat-shaped spray, wherein at least two pairs of the above-mentioned injection orifices are formed.

The jet direction, toward which the above-mentioned jet of each of the above-mentioned injection orifices is facing, is a direction in which these jets will impinge, and has a predetermined jet angle relative to a plane in the impinging direction comprising the axis of the above-mentioned needle valve, and, same is a direction in which the above-mentioned spray is formed, and faces toward a plane in the flat direction comprising the axis of the above-mentioned needle valve.

A third invention is an electromagnetic fuel injection valve, having an electromagnetic coil; a nozzle body, in which at least a pair of injection orifices are formed such that jets of injected fuel from the injection orifices impinge upon one another inside a combustion chamber; and a needle valve, which sits on the seat portion of this nozzle body, and which is capable of opening and closing the above-mentioned injection orifices by exciting the above-mentioned electromagnetic coil, the electromagnetic fuel injection valve being constituted such that the above-mentioned jets of fuel injected from the above-mentioned injection orifices are made to impinge upon one another, and are injected as a flat-shaped spray, wherein apertures of the above-mentioned injection orifices have cross-sectional shapes that differs from one another.

The aperture of one of the above-mentioned injection orifices can be formed to have an elliptical cross-sectional shape, while the aperture of the other of the above-mentioned injection orifices can be formed to have a circular cross-sectional shape.

A fourth invention is an electromagnetic fuel injection valve, having an electromagnetic coil; a nozzle body, in which forms at least a pair of injection orifices are formed such that jets of injected fuel from the above-mentioned injection orifices impinges upon one another inside a combustion chamber, a needle valve which sits on the seat portion of this nozzle body, and which is capable of opening and closing the above-mentioned injection orifices by exciting the above-mentioned electromagnetic coil, being constituted such that the above-mentioned jets resulting from fuel injected from the above-mentioned injection orifices are made to impinge upon one another, and are injected as a flat-shaped spray, this electromagnetic fuel injection valve being such that, in addition to the above-mentioned pair of injection orifices, a third injection orifice is formed therebetween.

As for the above-mentioned third injection orifice, this can be formed along the axis of the above-mentioned needle valve.

In an electromagnetic fuel injection valve according to the present invention, by applying various measures to an injection orifice, it is possible to give variation to the specifications of a spray produced as a flat shape, and flow specifications.

For example, in the first invention, since the angle of inclination of each of the injection orifices is made to differ from one to the other relative to the axis of the needle valve, by adjusting the relative angle of inclination thereof, it becomes possible to inject a flat-shaped spray having an arbitrary angle of deflection into a combustion chamber, and when the cylinder head or other such mounting part of an electromagnetic fuel injection valve is restricted, it is possible to aim a spray in an arbitrary direction in a combustion chamber, enabling this limitation to be dealt with precisely.

In the second invention, since at least two pairs of injection orifices are used, the wide angle (in a flat-shaped spray, the spreading angle of the side that spreads wider) of a spray resulting from a pair of injection orifices is determined by the angle and position of impingement, and by appropriately positioning the respective flat-shaped sprays achieved by the two pairs of jets thereof, it is possible to combine these sprays and to handle them as a single wide spray. Further, it is also possible to obtain a high injection quantity.

In the third invention, by forming injection orifices into aperture cross-sectional shapes that differ from one another, for example, by forming the injection orifice of the one side into a cross-sectional elliptical shape, and the injection orifice of the other side into a cross-sectional circular shape, in addition to ensuring the flow and spread of a fuel with the injection orifice of the one side, it is possible to achieve a flat-shaped spray.

In the fourth invention, in addition to a pair of injection orifices, since a third injection orifice is formed therebetween, it is possible to expand the wide angle so as to spread a flat-shaped spray resulting from a pair of injection orifices even wider, and, in addition, it is possible to increase the penetration of a spray.

### BRIEF DESCRIPTION OF THE DRAWINGS

FIG. 1 is a longitudinal cross-sectional view of the principal portion of an electromagnetic fuel injection valve 1 according to a first embodiment (first invention) of the present invention;

FIG. 2 is a bottom view, as seen from the combustion chamber 13 side, of an orifice plate 11 according to the first embodiment;

FIG. 3 is a side view of the wide angle side (side that spreads out wider) of a spray 17 according to the first embodiment;

FIG. 4 is a side view of the narrow angle side (side that becomes thinner and flatter) of a spray 17 according to the first embodiment;

FIG. 5 is a bottom view, as seen from the combustion chamber 13 side, of an orifice plate 11 in an electromagnetic fuel injection valve 20 according to a second embodiment (second invention) of the present invention;

FIG. 6 is a bottom view showing a flat-shaped spray resulting from a jet of injected fuel according to the second embodiment;

FIG. 7 is a bottom view, as seen from the combustion chamber 13 side, of an orifice plate 11 in an electromagnetic fuel injection valve 40 according to a third embodiment (third invention) of the present invention; and

FIG. 8 is a bottom view, as seen from the combustion chamber 13 side, of an orifice plate 11 in an electromagnetic fuel injection valve 50 according to a fourth embodiment (fourth invention) of the present invention.

### DESCRIPTION OF THE PREFERRED EMBODIMENTS

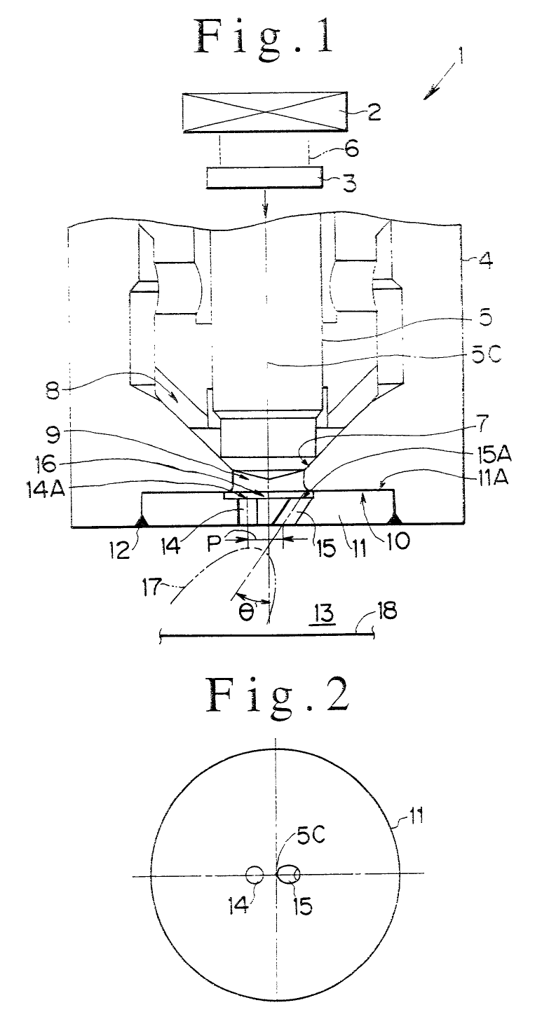

Next, an electromagnetic fuel injection valve 1 according to a first embodiment (first invention) of the present invention will be explained on the basis of FIG. 1 through FIG. 4.

FIG. 1 is a longitudinal cross-sectional view of the principal portion of an electromagnetic fuel injection valve 1, electromagnetic fuel injection valve 1 having an electromagnetic coil 2, an armature 3, a nozzle body 4, a needle valve 5, and a return spring 6.

A seat portion 7 of the needle valve 5 is formed on the nozzle body 4, and a fuel reservoir chamber 8 is formed on the upstream side thereof, and, in addition, an injection orifice upstream side space portion 9 is formed on the downstream side thereof, and a circular plate fastening space portion 10 is also formed on the downstream side, and the orifice plate 11 is fastened to this plate fastening space portion 10 via welding (weld portion 12) or the like. This orifice plate 11 part faces the combustion chamber 13.

FIG. 2 is a bottom view of an orifice plate 11 as seen from the combustion chamber 13 side.

This orifice plate 11 is a circular plate material with a rectangular shape longitudinal cross section thereof, and employs, for example, SUS304 or the like, which has excellent processability, and in the center portion thereof, a pair of injection orifices (a first injection orifice 14 and a second injection orifice 15) are facing each other. As for the nozzle body 4, it is generally necessary to constitute this using, for example, SUS440C or some other quenching material that has relatively high hardness, and the problem is that the processing of an injection orifice is difficult, but since the structure is such that an easy-to-process orifice plate 11 is fastened to the nozzle body 4, the processing of the first injection orifice 14 and the second injection orifice 15 can be accomplished more easily, and, in addition, the fastened structure thereof is also simple and reliable.

The first injection orifice 14 is parallel to the axis 5C of the needle valve 5 (an angle of inclination of zero), and the second injection orifice 15 is through-formed at a predetermined angle of inclination relative to the axis 5C. Furthermore, the first injection orifice 14 and the second injection orifice 15 have a relative spacing (pitch P), and open into a combustion chamber 13.

On the upstream surface 11A side of the injection orifice upstream side space portion 9 side of the orifice plate 11 there is formed a circular injection orifice introducing space portion 16, which faces the upstream side aperture portion 14A of the first injection orifice 14 and the upstream side aperture portion 15A of the second injection orifice 15.

This injection orifice introducing space portion 16 comprises on the inside thereof the upstream side aperture portion 14A of the first injection orifice 14 and the upstream side aperture portion 15A of the second injection orifice 15, and a high-pressure fuel is introduced into the inside of the first injection orifice 14 and the second injection orifice 15 via the injection orifice introducing space portion 16. Therefore, irrespective of the expansion, especially in the direction of the right and left sides in FIG. 1, or the capacity of the injection orifice upstream side space portion 9, that is, without changing the size of the injection orifice upstream side space portion 9 from the existing size, it is possible to form a first injection orifice 14 and a second injection orifice 15 at an arbitrary state of inclination in an arbitrary part of the orifice plate 11.

Furthermore, as the shape of the injection orifice introducing space portion 16, this shape is not limited to the above-mentioned circular shape, and if the upstream side aperture portion 14A of the first injection orifice 14 and the upstream side aperture portion 15A of the second injection orifice 15 are comprised on the inside thereof, for example, the minimum required channel is ensured, and, in addition, it is possible to employ an elliptical shape, or other arbitrary shape capable of reducing the dead volume thereof.

In an electromagnetic fuel injection valve of such a constitution, by exciting the electromagnetic coil 2, the armature 3 is driven in opposition to the biasing force of the return spring 6, the needle valve 5, which is integrally driven with this armature 3, is lifted from the seat portion 7, high-pressure fuel from the fuel reservoir chamber 8 is injected inside a combustion chamber 13 via the injection orifice upstream side space portion 9, the injection orifice introducing space portion 16, and also the first injection orifice 14 and the second injection orifice 15, and here, in accordance with the jets impinging upon each other, a flat-shaped spray 17 (fan spray) is formed.

A flat-shaped spray 17 (fan spray) is formed by the respective jets of injected fuel, which are injected from the pair of a first injection orifice 14 and a second injection orifice 15, impinging upon one another inside the combustion chamber 13.

More specifically, a pair of high-pressure jets from the pair of a first injection orifice 14 and a second injection orifice 15 spread out in a perpendicular direction in a plane comprising these jets from the impinging part thereof. That is, a spray 17 spreads out uniformly in an overall oval shape or flat shape such that the front side of the impinging direction of the jets becomes wide, and the side sides become narrow, and atomization of the fuel is achieved by the impinging of the jets, and, in addition, the mixing of the air and fuel inside the combustion chamber 13 is performed favorably.

Because the shape or configuration of this spray 17 is narrow and wide, the adherence of fuel to the top surface of a piston 18 at compression when the piston 18 rises up inside the combustion chamber 13 can be held in check, enabling the prevention of worsening emissions.

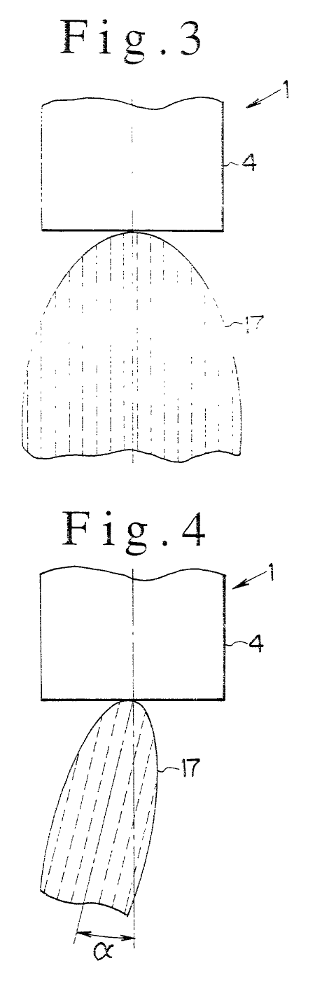

FIG. 3 is a side view of the wide-angle side of the spray 17 thereof (the side that spreads out further), and FIG. 4 is a side view of the narrow-angle side of the spray 17 thereof (the side that is thinner and flatter), and with a spray 17 of a shape such as this, the atomization of the fuel is promoted uniformly, and, in addition, the air/fuel mixture state inside the combustion chamber 13 can be made favorable.

However, since the first injection orifice 14 is parallel to the axis 5C of the needle valve 5, and the second injection orifice 15 has an angle of inclination θ relative to the axis 5C, in other words, since the injection orifices have attitudes that differ from one another, as shown in FIG. 4 in particular, a spray 17 comes to have an angle of deflection α, and is injected in a direction, which deviates from the direction from the axis 5C to the combustion chamber 13. Therefore, even when an electromagnetic fuel injection valve 1 is restricted by the mounting position of a cylinder head (not shown in the figures), a spray 17 can be deflected in an arbitrary direction, enabling a degree of freedom to be provided to the mounting position of an electromagnetic fuel injection valve 1.

Furthermore, a thin, wide spray configuration is maintained even under a back pressure environment resulting from piston 18 compression. Further, as for the penetration (penetrating force) of a spray 17, the control thereof can be performed by the fuel pressure.

Since an injection orifice introducing space portion 16 is formed on the upstream side surface 11A of the orifice plate 11, by ensuring the size or spread of the injection orifice introducing space portion 16 thereof, it is possible to control the position and size of the upstream side aperture portion 14A of the first injection orifice 14 and the upstream side aperture portion 15A of the second injection orifice 15, which are positioned on the inside thereof, the diameter, angle of inclination θ, and the pitch P of the first injection orifice 14 and the second injection orifice 15 can be selected with an arbitrary degree of freedom, and arbitrary spray specifications of a spray 17 and arbitrary flow specifications, such as a high injection quantity, can be achieved.

Thus, in accordance with the impingement of jets from the first injection orifice 14 and the second injection orifice 15, it is possible to form a flat-shaped spray 17, and, in addition, it is possible to increase the degree of freedom of injection into a combustion chamber 13 by atomizing the fuel and maintaining a thin, wide spray 17 configuration within a back pressure environment inside the combustion chamber 13.

Next, FIG. 5 is a bottom view, as seen from the side of the combustion chamber 13, of the orifice plate 11 in an electromagnetic fuel injection valve 20 according to a second embodiment (second invention) of the present invention, and two pairs of injection orifices (a first pair 21 and a second pair 22) are formed in the orifice plate 11.

The first pair 21 has a first injection orifice 23 and a second injection orifice 24, and the second pair 22 has a first injection orifice 25 and a second injection orifice 26.

The first pair 21 and second pair 22 are centered around the axis 5C of the needle valve 5, and are grouped top and bottom in FIG. 5 by a plane in the impinging direction 27, which passes through the axis 5C, causing the respective first injection orifice 23 and second injection orifice 24, and also the first injection orifice 25 and second injection orifice 26 to achieve plane symmetry relative to a plane in the flat direction 28 that is perpendicular to the plane in the impinging direction 27 thereof. Further, the first injection orifice 23 and second injection orifice 24, and also the first injection orifice 25 and second injection orifice 26 achieve plane symmetry relative to the plane in the impinging direction 27 as well.

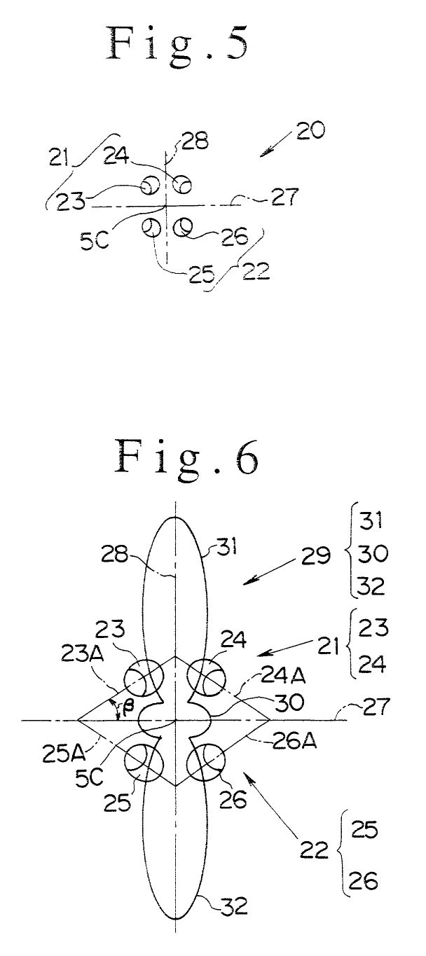

FIG. 6 is a bottom view similar to FIG. 5, which shows a flat-shaped spray resulting from jets of injected fuel, and the respective jet directions (first jet direction 23A and second jet direction 24A) of the first injection orifice 23 and second injection orifice 24 in the first pair 21 have a predetermined jet angle β relative to the plane in the impinging direction 27, which is different from the above-mentioned angle of inclination θ. Therefore, there is also a predetermined jet angle (90−β) relative to the plane in the flat direction 28.

The respective jet directions (first jet direction 25A and second jet direction 26A) of the first injection orifice 25 and second injection orifice 26 in the second pair 22 have a predetermined jet angle β relative to the plane in the impinging direction 27, which is different from the above-mentioned angle of inclination θ. Therefore, there is also a predetermined jet angle (90−β) relative to the plane in the flat direction 28.

Thus, the plane of symmetry comprises the axis 5C of the needle valve 5, and, in addition, fuel injection is performed such that the jets of the first pair 21 drift apart from one another relative to the jets of the second pair 22 in the direction of the plane of symmetry (plane in the flat direction 28) of each of the first pair 21 and the second pair 22. In other words, the first pair 21 and the second pair 22 are constituted so as to carry out fuel injection such that the jets thereof drift apart from one another.

In an electromagnetic fuel injection valve 20 of such a constitution, as shown in FIG. 6, the jets resulting from the first pair 21 and the second pair 22 combine on the plane in the flat direction 28 and become a flat-shaped spray 29 (fan spray), but the spray 29 comprises a center spray 30 resulting from the combined jets of the first pair 21 and the second pair 22, a first spray 31 resulting mainly from the first pair 21, and a second spray 32 resulting mainly from the second pair 22.

Therefore, it is possible to achieve a spray 29 having an arbitrary size and spread in accordance with two pairs of a first pair 21 and a second pair 22 in place of the pair of a first injection orifice 14 and a second injection orifice 15 in the electromagnetic fuel injection valve of FIG. 1, and an arbitrary required quantity can be ensured for the injection quantity as well.

Of course, pairs of injection orifices are not limited to two pairs, and can be constituted so as to cope with the requirements of a prescribed internal combustion engine by providing pairs of a number in excess thereof.

Furthermore, if another injection orifice (a central injection orifice, not shown in the figures) is formed in the position of the axis 5C of the needle valve 5, that is, along the axis 5C in the center portion of the first injection orifice 23 and second injection orifice 24 of the first pair 21, as well as the first injection orifice 25 and second injection orifice 26 of the second pair 22, the spread of a spray 29 will increase even further according to a jet from this central injection orifice, and, in addition, it is possible to increase the penetration of the tip portion of the center spray 30 thereof by extending same further forward, and it is possible to make the cross-sectional shape at the tip part of a spray 29 less bumpy, and smoother.

FIG. 7 is a bottom view, as seen from the side of the combustion chamber 13, of the orifice plate 11 in an electromagnetic fuel injection valve 40 according to a third embodiment (third invention) of the present invention, and shows in the orifice plate 11 a pair of injection orifices (a first injection orifice 41 and a second injection orifice 42), the aperture cross-sectional shapes of which differ from one another.

That is, as for the first injection orifice 41, the aperture cross-sectional shape thereof is an elliptical shape, and as for the second injection orifice 42, the aperture cross-sectional shape thereof is a circular shape.

A plane in the impinging direction 43 is formed passing through the center of the first injection orifice 41 and the second injection orifice 42, as well as through the axis 5C of the needle valve 5, a plane in the flat direction 44, which is orthogonal to this plane in the impinging direction 43 at the axis 5C, is formed, and the major axis of the first injection orifice 41 is positioned parallel to the plane in the flat direction 44.

Even in an electromagnetic fuel injection valve 40 of such a constitution, it is possible to achieve a flat-shaped spray in accordance with the jets from the first injection orifice 41 and the second injection orifice 42, and since it is possible to make the effective cross section of the channel of the first injection orifice 41 larger by forming the first injection orifice 41 inside the above-mentioned injection orifice introducing space portion 16 (FIG. 1) so as to be longer in the major axis direction thereof, a high flow rate spray can be achieved.

Furthermore, as the first injection orifice 41 and the second injection orifice 42, it is also possible to form these not in an elliptical shape and a circular shape, but rather as an injection orifice of a rectangular shape or a square shape.

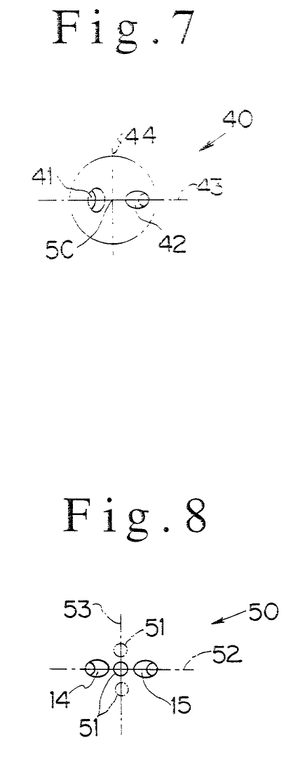

FIG. 8 is a bottom view, as seen from the side of the combustion chamber 13, of the orifice plate 11 in an electromagnetic fuel injection valve 50 according to a fourth embodiment (fourth invention) of the present invention, and in the orifice plate 11, there are formed the first injection orifice 14 and the second injection orifice 15 of the electromagnetic fuel injection valve 1 of FIG. 1, and a third injection orifice 51, which is positioned in a position central thereto.

The third injection orifice 51 is made to correspond to the axis 5C of the needle valve 5, and is formed so as to pass therethrough, and the first injection orifice 14, the third injection orifice 51 and the second injection orifice 15 are positioned in a straight line on a plane in the impinging direction 52.

In an electromagnetic fuel injection valve 50 of such a constitution, in addition to a flat-shaped spray in accordance with the first injection orifice 14 and the second injection orifice 15, because a linear jet from the third injection orifice 51 passes through the center of the spray thereof, and is injected into a combustion chamber 13, it is possible to spread out the spray in a wide angle, and, in addition, to strengthen the penetration thereof.

Further, by changing the formation position thereof along a plane in the flat direction 53, which is orthogonal to the plane in the impinging direction 52, as indicated by the virtual line in FIG. 8, it is possible to arbitrarily change the generation position of the penetration of a flat-shaped spray.

As described hereinabove, according to the present invention, it is possible to arbitrarily adjust the specifications of a flat-shaped spray, and flow specifications in accordance with the attitude, number, shape, and additional formation of injection orifices, and it is possible to increase the degree of freedom of functionality of an electromagnetic fuel injection valve for in-cylinder direct fuel injection, such as in an in-cylinder gasoline injection system.

What is claimed is:

1. An electromagnetic fuel injection valve, having:
an electromagnetic coil;
a nozzle body, in which at least a pair of injection orifices are formed such that jets of injected fuel from these injection orifices impinge upon one another inside a combustion chamber; and
a needle valve, which sits on the seat portion of this nozzle body, and which is capable of opening and closing said injection orifices by exciting said electromagnetic coil,
said electromagnetic fuel injection valve being constituted such that said jets of fuel injected from said injection orifices are made to impinge upon one another, and are injected as a flat-shaped spray,
wherein the angles of inclination of said injection orifices relative to the axis of said needle valve are made to differ from one another.

2. The electromagnetic fuel injection valve according to claim 1, wherein, one of said injection orifice is formed parallel to said axis of said needle valve, and the other of said injection orifice is formed so as to have a predetermined angle of inclination relative to said axis of said needle valve.

3. An electromagnetic fuel injection valve, having:
an electromagnetic coil;
a nozzle body, in which at least a pair of injection orifices are formed such that jets of injected fuel from these injection orifices impinge upon one another inside a combustion chamber; and
a needle valve, which sits on the seat portion of this nozzle body, and which is capable of opening and closing said injection orifices by exciting said electromagnetic coil,
said electromagnetic fuel injection valve being constituted such that said jets of fuel injected from said injection orifices are made to impinge upon one another, and are injected as a flat-shaped spray,
wherein at least two pairs of said injection orifices are formed.

4. The electromagnetic fuel injection valve according to claim 3, wherein the jet direction, toward which each of said jets from said injection orifices is facing, is a direction in which these jets will impinge, and has a predetermined jet angle relative to a plane in the impinging direction including the axis of said needle valve, and same is a direction in which said spray is formed, and faces toward a plane in the flat direction including the axis of said needle valve.

5. An electromagnetic fuel injection valve, having:
an electromagnetic coil;
a nozzle body, in which forms at least a pair of injection orifices are formed such that jets of injected fuel from said injection orifices impinges upon one another inside a combustion chamber; and
a needle valve, which sits on the seat portion of this nozzle body, and which is capable of opening and closing said injection orifices by exciting said electromagnetic coil,
said electromagnetic fuel injection valve being constituted such that said jets of fuel injected from said injection orifices are made to impinge upon one another, and are injected as a flat-shaped spray,
wherein apertures of said injection orifices have cross-sectional shapes that differs from one another.

6. The electromagnetic fuel injection valve according to claim 5, wherein, as for said injection orifice of the one side, the aperture cross-sectional shape thereof is formed in a elliptical shape, and, in addition, as for said injection orifice of the other side, the aperture cross-sectional shape thereof is formed in a circular shape.

7. An electromagnetic fuel injection valve, having:
an electromagnetic coil;
a nozzle body, in which forms at least a pair of injection orifices are formed such that jets of injected fuel from said injection orifices impinges upon one another inside a combustion chamber; and
a needle valve, which sits on the seat portion of this nozzle body, and which is capable of opening and closing said injection orifices by exciting said electromagnetic coil,
said electromagnetic fuel injection valve being constituted such that said jets of fuel injected from said injection orifices are made to impinge upon one another, and are injected as a flat-shaped,
wherein, in addition to said pair of injection orifices, a third injection orifice is formed therebetween.

8. The electromagnetic fuel injection valve according to claim 7, wherein, said third injection orifice is formed along the axis of said needle valve.
